(19) United States
(12) Patent Application Publication
(10) Pub. No.: US 2023/0211314 A1
(43) Pub. Date: Jul. 6, 2023

(54) ZEOLITES WITH IMPROVED COMPATIBILITY

(71) Applicant: Arkema France, Colombes (FR)

(72) Inventors: Guillaume Ortiz, Lacq (FR); Cécile Lutz, Lacq (FR); Thierry Vassalo, Colombes (FR); Karine Lopez, Lacq (FR)

(73) Assignee: Arkema France, Colombes (FR)

(21) Appl. No.: 17/928,415

(22) PCT Filed: Jun. 2, 2021
(86) PCT No.: PCT/FR2021/051001

§ 371 Date: Nov. 29, 2022

(30) Foreign Application Priority Data
Jun. 2, 2020 (FR) 2005763

(51) Int. Cl. B01J 20/18; C08K 9/08; C08K 3/34; B01J 20/28

(52) U.S. Cl. CPC B01J 20/186; C08K 9/08; C08K 3/34; B01J 20/28026

(57) ABSTRACT

The invention relates to modified zeolite crystals comprising zeolite crystals and from 0.5% to 20%, by weight, endpoints included, relative to the total weight of modified zeolite crystals, of at least one polymeric compatibilizer, more particularly a functional polyolefin.

The invention also relates to the use of the modified zeolite crystals according to the invention as a filler in a polymer matrix, for example for the preparation of composite materials.

### CROSS-REFERENCE TO RELATED APPLICATIONS

This application is a 371 filing of International Application No. PCT/FR2021/051001, filed Jun. 2, 2021, which claims priority to French Application No. 2005763 filed Jun. 2, 2020, the disclosures of these applications being incorporated herein by reference in their entireties for all purposes.

### FIELD OF THE INVENTION

The invention relates to the field of zeolitic adsorbents, more particularly to that of composite materials comprising zeolitic adsorbents, and especially of composite materials comprising zeolitic adsorbents dispersed in organic matrices.

### BACKGROUND OF THE INVENTION

Increasing numbers of applications nowadays require the incorporation of a large proportion of zeolitic adsorbent or adsorbents (more simply “zeolite(s)”) in polymer matrices, particularly when the zeolite is used as an active ingredient for adsorption purposes such as water adsorption or the adsorption of volatile organic compounds.

In that case the polymer matrix serves only as an agglomerating binder to shape the zeolite into an adsorbent article, in the form for example of adsorbent strips, molded or extruded parts, or seals.

Patent application FR2939330 describes a zeolitic adsorbent material with organic binder that contains from 65% to 99% of zeolite in the form of crystals which are incorporated directly into the polymer matrix. The technique for incorporating the crystals into the polymer is that of mixing in a twin screw extruder. This technique requires a relatively substantial amount of energy and shows the poor compatibility between the zeolite and the organic matrix.

Because of this “incompatibility” generally observed between the inorganic zeolites and the organic polymer matrices, the zeolites are generally incorporated in only a relatively low amount into the polymer matrices. This is one of the reasons why zeolite crystals are often used as filler materials in, for example, flame retardant compositions, as described for example in documents EP0629678, FR3062390 and EP1375594. The amount by weight of zeolite in the material in that case does not generally exceed 10%.

Zeolites may also act as a carrier for an active principle, as for example for amines that can control the crosslinking of a crosslinkable polymer composition based on polymer having maleic anhydride groups (U.S. Pat. No. 5,792,816). The zeolite content is again generally less than 20%.

Although yet further uses have been studied for the zeolites, the amounts by weight remain low, essentially due to the mediocre compatibility between inorganic zeolites and organic matrices. In such applications, the zeolites are used in small amounts, in order for example to provide ad hoc dehydration properties, as in the production of polyurethanes, for example, to remove traces of water in isocyanate and polyol formulations and so to prevent the formation of bubbles in the polymer, or else to trap traces of residual monomers in the polymer material.

In other cases, the zeolite endows the composition with particular properties, as is the case, for example, in document FR2811304, which accordingly describes fungistatic packaging based on polyolefins or polystyrenes containing up to 30% of zeolite crystals partially exchanged with silver.

Application WO2009032869 in turn describes a dehydrating composition obtained by mixing a polyolefinic organic binder and a zeolitic adsorbent component at a level of 55% to 77%. This composition is used for producing dehydrating seals for double glazing. However, the use of such compositions is not very easy: the times for incorporation of the adsorbent solid in the preparation are long and the mixture is very viscous.

The present state of the art thus shows that there remains a need today which has not yet been fully satisfied for the incorporation of zeolite in high proportion into a polymer matrix under conditions of use that are compatible with industrial exploitation.

Incorporating a high proportion of one or more zeolites into a polymer matrix is a delicate, often fairly lengthy and energy-intensive operation, and consequently any solution aimed at reducing the mixing time for the various ingredients of the formulation and/or reducing the associated energy consumption, or else at increasing, for the same productivity, the proportion of zeolite(s) in the polymer matrix, would be very useful and greatly appreciated.

### SUMMARY OF THE INVENTION

One of the objectives of the present invention, accordingly, is to provide zeolites of improved compatibility toward organic materials, such as organic polymers. Another objective of the present invention is to provide zeolites of improved compatibility toward organic materials, and to incorporate substantial amounts of said zeolites into said organic materials. Yet another objective is to provide zeolites of improved compatibility that are readily preparable and easily employable in industry, with relatively low production costs and controlled energy consumption.

The inventors have now found that these objectives are achievable, entirely or at least in part, by virtue of the present invention. Other, further objectives will become apparent from the description which follows.

It has indeed now been found that it is possible to improve substantially the compatibility or affinity of zeolite crystals, i.e., of adsorbent materials (that is, of activated crystals, being crystals having undergone a heat treatment), with polymers especially in order to enhance the incorporation of said zeolites in high proportion into a polymer matrix and/or, for the same productivity, to increase the proportion of zeolite incorporated into the polymer matrix, while retaining good mechanical properties and in some cases imparting entirely unexpected properties to the polymers and composite materials incorporating the zeolite crystals modified according to the invention.

Accordingly, and in a first aspect, the present invention relates to modified zeolite crystals comprising zeolite crystals and from 0.5% to 20%, preferably from 0.5% to 15%, more preferably from 1% to 10%, and advantageously from 1% to 5%, by weight, endpoints included, relative to the total weight of modified zeolite crystals, of at least one polymeric compatibilizer, more particularly a functional polyolefin.

In the present invention, the zeolite crystals are zeolitic adsorbent materials which are well known to those skilled in the art and may be of any types used in the adsorption field, and preferred examples of zeolites comprise, without limitation, LTA zeolites, preferably 3A, 4A and 5A, FAU zeolites, preferably of type X, LSX, MSX and Y, MFI zeolites, preferably of type ZSM-5 and silicalites, P zeolites, SOD zeolites (such as sodalites), MOR zeolites, CHA zeolites (such as chabazites), HEU zeolites (such as clinoptilolites), and mixtures of two or more thereof in any proportions.

For the needs of the present invention, preferred zeolites are those selected from LTA zeolites, preferably 3A, 4A and 5A, FAU zeolites, preferably of type X, LSX, MSX and Y, P zeolites, SOD zeolites (such as sodalites), MOR zeolites, CHA zeolites (such as chabazites), HEU zeolites (such as clinoptilolites), and mixtures of two or more thereof in any proportions.

The previously mentioned zeolites may be natural, artificial or synthetic, in other words natural, modified or synthesized. The zeolites usually contain one or more types of cations in order to ensure their electronic neutrality. The cations present in the zeolites naturally or after one or more cation exchanges are well known to those skilled in the art. Non limiting examples of such cations include the cations of hydrogen, of alkali metals, of alkaline earth metals, of metals from groups VIII, IB and IIB, and mixtures of two or more thereof, and examples of cations usually comprise the cations of lithium, potassium, sodium, barium, calcium, silver, copper, zinc, and mixtures of two or more thereof in any proportions.

The number-average size of the crystals (more simply “size of the crystals” in the rest of the description) may vary within wide proportions and is generally between 0.05 μm and 20 μm, preferably between 0.1 μm and 20 μm, more preferably between 0.1 μm and 10 μm, advantageously between 0.2 μm and 10 μm, preferably between 0.3 μm and 8 μm, better still between 0.5 μm and 5 μm.

The modified zeolite crystals of the present invention further comprise at least one polymeric compatibilizer, more particularly a functional polyolefin, as indicated above.

In one embodiment of the invention, the compatibilizer used, preferably said at least one functional polyolefin, for preparing the modified zeolite crystals has a melt flow index (MFI) of more than 250 g/10 min, measured according to standard ASTM D1238 (190° C., 2.16 kg), preferably of between 250 g/10 min and 1000 g/10 min, more preferably of between 300 g/10 min and 950 g/10 min, better still between 500 g/10 min and 900 g/10 min, and very preferably indeed between 550 g/10 min and 900 g/10 min.

According to one preferred embodiment, the melting temperature of said compatibilizer is less than 150° C., more preferably less than 120° C., advantageously less than 110° C., and better still less than 100° C.

The compatibilizer is a polymer, preferably a polyolefin and more specifically still a functional polyolefin.

### BRIEF DESCRIPTION OF THE DRAWINGS

FIG. 1 is a photograph obtained by SEM (magnification 5000) showing 3A zeolite crystals almost entirely covered by a thin layer of polyolefin.

FIG. 2 is a photograph obtained by SEM (magnification 5000) of this mixture, which is not according to the invention.

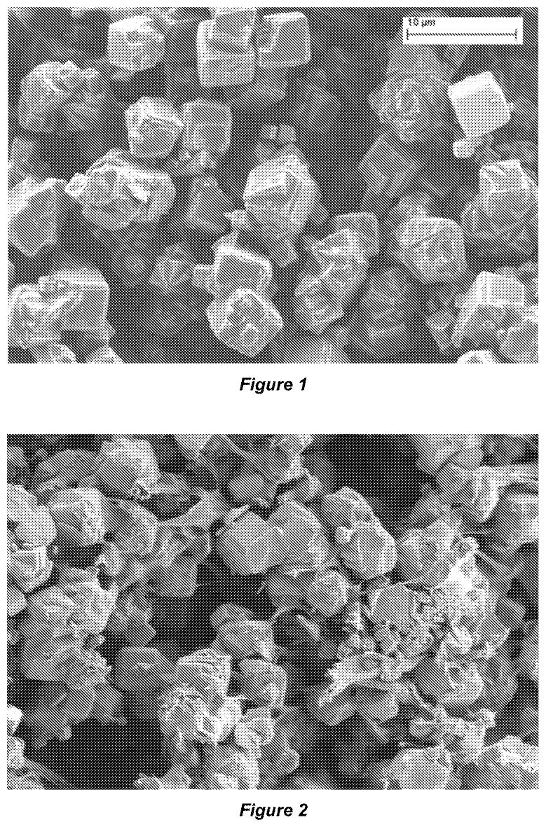

### DETAILED DESCRIPTION OF THE INVENTION

“Polyolefins” are the homopolymers or copolymers of alpha-olefins or diolefins. These olefins are, by way of example, ethylene, propylene, but-1-ene, oct-1-ene, butadiene, styrene, and others, and also mixtures of two or more thereof in any proportions.

Polyolefins as a term also embraces the mixtures of two or more homopolymers and/or copolymers stated above. Non limiting examples of possible polyolefins include polyethylene (HDPE, LDPE or VLDPE), polypropylene, and their copolymers. The number-average molecular weight of the polyolefins may vary to a wide degree, and is generally between 1000 g/mol and 1 000 000 g/mol.

These polyolefins or copolyolefins may, moreover, be grafted or “functionalized” with diverse functional groups, well known to those skilled in the art, such as for example unsaturated carboxylic or dicarboxylic acid anhydrides, such as maleic anhydride, or unsaturated epoxides such as glycidyl methacrylate.

According to another embodiment, the polyolefins thus functionalized, called functional polyolefins, may be prepared by homopolymerization of functionalized monomers or copolymerization of olefins with functionalized comonomers or else copolymerization of functionalized olefins with optionally functionalized comonomers, said functionalized monomers or comonomers being advantageously and most generally selected from unsaturated carboxylic acids, salts thereof and esters thereof, such as alkyl (meth)acrylates, as for example methyl acrylate, vinyl esters of saturated carboxylic acids such as vinyl acetate, unsaturated dicarboxylic acids, salts thereof, esters thereof, monoesters thereof, anhydrides thereof, unsaturated epoxides, and others, and also mixtures of two or more thereof in any proportions. Generally speaking, a “functionalized polyolefin” or “functional polyolefin” is a polyolefin that may be referred to generically as a “functionalized polyolefin” and is known to be a polymer of one or more olefins with at least one polar or nonpolar functionality bonded to the polymer chain. According to one preferred aspect of the present invention, preferred olefin polymers are those with at least one polar functionality. According to one preferred aspect of the present invention, the term “functional polyolefin” does not include halogenated polyolefins.

Accordingly, and in one embodiment of the invention, when the compatibilizer is a copolymer, and preferably a copolymer with an olefinic component, said copolymer is advantageously selected from olefin/carboxylic acid (optionally in salt form or in ester form) copolymers and copolymers of olefins and vinyl esters of carboxylic acids, to state only the most common olefinic copolymers.

Possible olefin/carboxylic acid (optionally in salt form or in ester form) copolymers also include olefin/unsaturated carboxylic acid copolymers, optionally in salt form or in ester form. Examples of carboxylic acids, salts or esters appropriate for the needs of the present invention include, particularly, acrylic and methacrylic acids, salts or esters thereof, and especially methyl acrylate or butyl acrylate.

Possible copolymers of olefins and vinyl esters of carboxylic acids include copolymers of olefins and vinyl esters of saturated carboxylic acids, and more particularly olefin/vinyl acetate copolymers.

It should be appreciated in the sense of the present invention that the polymeric compatibilizer may comprise one or more polymers and/or copolymers as just defined, and more particularly olefinic polymers and/or copolymers as just defined.

According to one particular embodiment, the amount (by number, determined by infrared spectrometry) of functionalized comonomers is from 10% to 40% in the copolymer.

The zeolite crystals modified according to the present invention, i.e., the crystals comprising at least one compatibilizer as indicated above, are in the form of free crystals (that is, free powder) or in the form of friable crystal aggregates. In other words, the crystals according to the present invention are crystals not joined to one another, except for any crystal aggregates, and these crystals not joined to one another are zeolite crystals comprising at least one polymeric compatibilizer, preferably at least one functional polyolefin.

The number-average size of the modified crystals (more simply “size of the modified crystals” in the rest of the description) according to the present invention is generally between 0.07 μm and 25 μm, preferably between 0.1 μm and 20 μm, more preferably between 0.1 μm and 10 μm, advantageously between 0.2 μm and 10 μm, more preferably between 0.3 μm and 8 μm, better still between 0.5 μm and 5 μm.

According to another aspect, the present invention relates to the process for preparing zeolite crystals modified according to the invention, i.e., zeolite crystals comprising at least one compatibilizer. This process is characterized in that it comprises the following steps:

a) mixing the zeolite crystals with said at least one compatibilizer, and

b) recovering the modified zeolite crystals.

The compatibilizer used in step a) may be either melted or ground, by cryomilling for example, prior to being mixed with the zeolite crystals. The compatibilizer may be in the solid or the melted state before and/or during mixing. The modified zeolite crystals recovered are in the form of pulverulent crystals, and/or of friable aggregates, as indicated above. The modified zeolite crystals are pulverulent crystals, and/or in the form of friable aggregates, usually and most generally obtained in a melting step after or during the mixing with at least one compatibilizer as defined above, this being either a melting of said at least one compatibilizer by application of an external heat source, and/or an at least partial melting of said at least one compatibilizer by the forces of friction in the mixer, during mixing.

The mixing of the zeolite crystals with said at least one compatibilizer may be carried out batchwise or continuously, by means of suitable mixers which are well known to those skilled in the art and which comprise, as non limiting examples, Brabender-type mixers, for example with rotating blades and of various forms suitable for each type of matrix, Banbury-type devices in which two spiral rotors turn in opposite directions at a variable speed of rotation, extruders, single-screw or double-screw, such as for example Buss-type kneaders, which are generally equipped with a screw oscillating axially with a sinusoidal movement.

Extruders are particularly well suited for continuous processes, whereas Brabender or Banbury mixers are more suited to batch processes. These various types of mixers are able to withstand the temperatures applied, which are adapted to the melting temperature of the compatibilizer, where appropriate.

The zeolite crystals may be introduced in one or more additions or, better still, in portions into the mixture. According to one advantageous embodiment of the present invention, the mixers used comprise a plurality of feed zones, thereby favoring and greatly facilitating the mixtures with a high zeolite crystal content.

It is also possible, if necessary or desirable, to add diverse additives and/or fillers to the zeolite crystals, before and/or during and/or after the addition of said at least one compatibilizer. The additives and fillers which may thus be incorporated are those which are well known to those skilled in the art and which generally comprise, as non limiting examples, crosslinking agents, antibacterial agents, fungicides, antifogging agents, swelling agents, dispersants, flame retardants, pigments, lubricants, impact modifiers, antioxidants, and others and mixtures thereof, to cite only the principal representatives among them.

For the needs of the process according to the invention, preference is given to using zeolite crystals which beforehand have been activated, i.e., desorbed of the adsorbed water by heat treatment, and which more generally have a very low residual water content, typically with a loss on ignition (LOI) of less than 2%. The loss on ignition is determined under an oxidizing atmosphere, by calcination of the crystals in air, at a temperature of 950° C.±25° C., as described in standard NF EN 196-2 (April 2006). The measurement standard deviation is less than 0.1%.

At the end of the process of the invention, modified zeolite crystals are obtained, specifically a zeolite in the form of crystals and comprising said at least one compatibilizer. These modified zeolite crystals are ready to be used, after optional storage, under conditions which are well known to those skilled in the art for the storage of adsorbent materials.

The modified zeolite crystals thus comprise at least one compatibilizer, said at least one compatibilizer possibly being present and visible by scanning electron microscopy (SEM) in various forms, and for example in the form of particles intimately mixed with the zeolite crystals, and/or else as a thin layer of compatibilizer on the surface of the crystals, and/or other forms, and also combinations of these various forms.

According to one preferred embodiment, when the compatibilizer is present in the form of particles intimately mixed with the zeolite crystals, said particles have a number-average size of less than 100 μm, preferably less than 80 μm, more preferably less than 60 μm, and preferably a number-average size of between 0.1 μm and 100 μm, preferably between 0.5 μm and 80 μm, more preferably between 1 μm and 60 μm, the number-average size being measured by SEM as indicated later on below. Compatibilizer particles of such sizes may be obtained by any means well known to those skilled in the art and for example by cryomilling, as indicated earlier.

According to another embodiment, the compatibilizer is present in the form of a thin layer covering part or all of the surface of the zeolite crystals, said layer preferably having a thickness, observed using a scanning electron microscope (SEM) or even a transmission electron microscope (TEM), of less than 1.0 μm, advantageously less than 0.5 μm, preferably less than 0.2 μm.

The compatibilizer layer covering part or all of the surface of the zeolite crystals is generally obtained by mixing said zeolite crystals with the compatibilizer at a temperature preferably at least greater than the melting temperature of said compatibilizer.

As indicated above, the zeolite crystals comprising at least one compatibilizer according to the invention, i.e., the zeolite crystals modified with at least one compatibilizer, are zeolite crystals or friable crystal aggregates and have entirely unexpected properties in terms of compatibility with organic matrices, especially polymeric matrices.

In particular it has been shown, surprisingly, that the zeolite crystals modified according to the invention are incorporated much more easily into polymeric matrices, thereby directly implying a great number of advantages, including among others a reduced energy consumption, a quicker rate of incorporation, a better rheological behavior (for example, reduction in viscosity), and a higher proportion of zeolite crystals in the polymeric matrices.

The polymeric matrices into which the zeolite crystals modified according to the present invention may usefully be incorporated may be of any type and especially the polymeric matrices which are conventionally filled with zeolite crystals, but also other types of polymeric matrices which have to date been unable to contain zeolite crystals or have been able to contain them only in small amounts.

Hence the polymer materials that can be used as a matrix for the zeolite crystals modified according to the invention may in particular and preferably be thermoplastic polymers, including, as non limiting examples, polyethylenes, ethylene elastomers, propylene rubbers (EPR), ethylene, propylene and diene elastomers (EPDM), mixtures thereof, polyisobutylenes, silicones, polyurethanes, and also the copolymers, and the mixtures of these polymers. Said polymeric matrices comprising the modified zeolite crystals may then optionally be crosslinked or vulcanized, according to conventional techniques well known to those skilled in the art.

The incorporation of the zeolite crystals modified according to the invention into the polymeric matrices is generally carried out by the techniques known to those skilled in the art, and generally by the conventional and known conversion techniques for plastics, such as kneading, extrusion, extrusion with molding, kneading with molding, and others, and also combinations of these techniques.

These incorporation techniques may also include the incorporation of various additives and fillers, also well known in the field, to endow the zeolite-filled polymeric matrix with additional properties. These additives and fillers include, as non limiting examples, crosslinking agents, antibacterial agents, fungicides, antifogging agents, swelling agents, dispersants, flame retardants, pigments, lubricants, impact modifiers, antioxidants, and others and mixtures thereof, to cite only the principal representatives among them.

The modified zeolite crystals of the present invention thus provide access to zeolite-filled polymeric matrices endowed with remarkable properties. In particular it has been shown, surprisingly, that the zeolite crystals modified according to the invention are incorporated much more easily into polymeric matrices, thereby directly implying a great number of advantages, including among others a reduced energy consumption, a quicker rate of incorporation, a better rheological behavior (for example, reduction in viscosity), and a higher proportion of zeolite crystals in the polymeric matrices.

These assorted remarkable properties enable market access to polymer materials with lower production costs and/or with improved adsorption properties, and/or improved mechanical properties (such as elasticity, resistance to crushing, to elongation, to breaking, to shear, etc.).

The invention also relates to the use of the zeolite crystals modified according to the invention as a filler in a polymer matrix, especially for the preparation of composite materials. In this regard, the zeolite crystals modified according to the invention find very interesting applications in a great many fields of industry, and especially as fillers in polymeric matrices (or polymer compositions).

On account of their improved compatibility, the zeolite crystals modified according to the invention may be incorporated into polymeric matrices in substantial or even very substantial amounts, as for example in amounts of at least 40%, even at least 60%, even at least 80% or more.

Accordingly, the zeolite crystals modified according to the invention may thus be used as fillers in polymeric matrices, and find very interesting applications in the fields of double glazing and of coating compositions, of for example polyurethane coatings or coatings for metallic substrates such as aluminum or coatings for glass, or else in the field of formulations ready to be polymerized, formulations ready to be crosslinked, and also as a filler in materials having reinforced mechanical properties, flame retardant properties and acoustic properties, and for applications in the electrical and electronics fields, such as cabling and connectors, and others.

The invention is now illustrated by the examples that follow, which are not in any way limiting.

### EXAMPLES

In the examples that follow, the following analytical techniques have been used:

### Crystal Size and Morphology (SEM)

The size of the various materials (crystals and compatibilizer, in cryomilled form) is estimated by observation with a scanning electron microscope (SEM). For this purpose, a set of images is taken at a magnification of at least 5000. The size of at least 200 elements is then measured using dedicated software, as for example the Smile View software published by LoGraMi. The accuracy is of the order of 3%. The “size” is defined as being the largest dimension of the element. The resulting particle size distribution is equivalent to the mean of the particle size distributions observed for each of the images. The number-average size is calculated by conventional methods known to those skilled in the art, applying the statistical rules of Gaussian distribution.

The morphology of the crystals and the modification of the surface of the crystals are qualified on the basis of SEM photos taken at the magnification appropriate to the size of the crystals (for example, magnification of between 4000 and 20 000).

### Example 1 According to the Invention

### Preparation of Crystals of 3A Zeolite Modified with a Functional Polyolefin

A Lotryl® 28BA700T grade polyolefin from Arkema in pellet form (10 g) is introduced into a HAAKE™ Rheomix® 600 Brabender mixer, at 100° C. and 50 revolutions per minute. After the polyolefin has melted at this temperature, Siliporite® NK30AP 3A zeolite crystals from Arkema (190 g) in powder form are added to the mixer in portions. After mixing for 20 minutes, a homogeneous mixture of modified zeolite crystals (200 g) is obtained in the form of free powder and highly friable aggregates, which is left to cool to ambient temperature in the absence of moisture in a Schlenk vessel.

### Example 1a (Comparative)

### Preparation of Crystals of 3A Zeolite Modified with a Nonfunctional Polyolefin

Polypropylene (Sigma Aldrich, isotactic grade, Mw ˜250 000, Mn ˜67 000) in pellet form (10 g) is introduced into a HAAKE™ Rheomix® 600 Brabender mixer, at 160° C. and 50 revolutions per minute. After the polyolefin has melted at this temperature, Siliporite® NK30AP 3A zeolite crystals from Arkema (190 g) in powder form are added to the mixer in portions. After mixing for 20 minutes, a mixture of agglomerates of crystals entrapped in the polypropylene and free, unmodified zeolite crystals is obtained.

### Example 2

### Use of the Modified 3A Zeolite Crystals in a Silicone Matrix

A peroxide-type crosslinking agent, Luperox P from Arkema (3.6 g), is first added with stirring to 200 g of modified zeolite crystals obtained in example 1.

This premix is then introduced into 190 g of a silicone polymer matrix (Silicone 4-7155 from Dow Corning) using a double-roll mixer. Mixing is carried out for about 15 minutes at ambient temperature (20° C.). The rotary speeds of the rolls (diameter 150 mm) are different: 18 revolutions per minute (rpm) for the rear roll and 24 rpm for the front roll. The spacing between the two rolls is about 3 mm. A homogeneous mixture is obtained in the form of a sheet with a length of about 60 cm and a width of about 15 cm and a thickness of 3 mm.

### Use of the Unmodified 3A Zeolite Crystals in a Silicone Matrix (Comparative Example)

A peroxide-type crosslinking agent, Luperox P from Arkema (3.6 g), is added to 190 g of Siliporite® NK30AP 3A zeolite crystals from Arkema.

The mixture obtained is then introduced into 200 g of a silicone polymer matrix (Silicone 4-7155 from Dow Corning) using a double-roll mixer. Mixing is carried out for about 15 minutes at ambient temperature. The rotary speeds of the rolls (diameter 150 mm) are different: 18 rpm for the rear roll and 24 rpm for the front roll. The spacing between the two rolls is about 3 mm. The homogeneous mixture is obtained in the form of a sheet with a length of about 60 cm and a width of about 15 cm and a thickness of 3 mm.

### Rheological Comparison

Measurements of the rheological behavior are then performed on the resulting sheets by means of an oscillating-matrix plate/plate rheometer (France Scientifique model MDR-C) at 130° C. for 45 min, during which time the silicone matrix undergoes crosslinking. The rheometer is operated according to the standards ISO 6502 and ASTM D5289.

The sheet prepared with the zeolite crystals modified according to the invention is observed to exhibit a minimum torque lower than that obtained with the unmodified zeolite crystals (a reduction of the order of 30%, or even less), thereby demonstrating that a smaller amount of energy is needed to mix the zeolite crystals modified according to the invention with the polymer matrix. Indeed, a greater fluidity (reduced viscosity) is observed on the part of the mixture with the crystals modified according to the invention.

### Comparison of Tensile Stresses-Strains

Tensile strain measurements are then carried out with application of the standard ISO 37:2017. To be able to carry out these measurements, it is necessary firstly to crosslink the silicone by heating the sheets in a Darragon pneumatic press at 200° C. for 5 minutes, under a pressure of 150 bar (15 MPa). After resting for 24 hours in the absence of moisture, type 2 dumbbell specimens in conformity with ISO 37:2017 are then cut from the sheets using a CEAST punch. The tensile strain measurements are then carried out using an Instron model 4505 tensile testing machine.

The elongation at break observed is greater with the samples comprising the crystals modified according to the invention, and it is observed that this elongation can attain values up to 25% greater relative to test specimens comprising the same amount of conventional—that is, unmodified—zeolite crystals.

1. Modified zeolite crystals comprising zeolite crystals and from 0.5% to 20% by weight, endpoints included, relative to the total weight of modified zeolite crystals, of at least one polymeric compatibilizer.

2. The modified crystals as claimed in claim 1, wherein the zeolite crystals are zeolitic adsorbent materials selected from LTA zeolites, FAU zeolites, MFI zeolites, P zeolites, SOD zeolites, MOR zeolites, CHA zeolites, HEU zeolites, and mixtures of two or more thereof in any proportions.

3. The modified crystals as claimed in claim 1, wherein the zeolite crystals have a number-average size of between 0.05 μm and 20 μm.

4. The modified crystals as claimed in claim 1, wherein the compatibilizer has a melt flow index of more than 250 g/10 min, measured according to standard ASTM D1238 (190° C., 2.16 kg).

5. The modified crystals as claimed in claim 1, wherein the melting temperature of said compatibilizer is less than 150° C.

6. The modified crystals as claimed in claim 1, wherein the compatibilizer is a polymer.

7. The modified crystals as claimed in claim 1, wherein the compatibilizer is selected from homopolymers or copolymers of alpha-olefins or diolefins, optionally functionalized with one or more functional groups selected from unsaturated carboxylic or dicarboxylic acid anhydrides and unsaturated epoxides, and copolymers of olefins with functionalized comonomers.

8. The modified crystals as claimed in claim 1, having a number-average size of between 0.07 μm and 25 μm.

9. The use of the modified crystals as claimed in claim 1 as a filler in a polymer matrix.

10. The use as claimed in claim 9 as fillers in polymer matrices for applications in the fields of double glazing, coating compositions, formulations ready to be polymerized, formulations ready to be crosslinked, and also for applications as a filler in materials having reinforced mechanical properties, flame retardant properties and acoustic properties, and for applications in the electrical and electronics fields, and others.
